(19) United States
(12) Patent Application Publication
(10) Pub. No.: US 2001/0020336 A1
(43) Pub. Date: Sep. 13, 2001

(54) Apparatus for measuring height of mounting positions of cutting knife and pressure bar in veneer lathe

(76) Inventor: Ryoichi Tadaki, Chuo-ku (JP)

Correspondence Address: HESLIN & ROTHENBERG FARLEY & MESITI PC, 5 COLUMBIA CIRCLE, ALBANY, NY, 12203, US

(21) Appl. No.: 09/802,301

(22) Filed: Mar. 8, 2001

(30) Foreign Application Priority Data
Mar. 13, 2000 (JP) 2000-117252

(51) Int. Cl. G01B 5/18

(52) U.S. Cl. 33/833; 33/628

(57) ABSTRACT

An apparatus includes a main plate, a level capable of checking a level state of a bottom surface of the main plate in a longitudinal direction, a fixed measure provided for the main plate on an end side and having a feed section perpendicular to the bottom surface of the main plate, and a moving measure held in the fixed measure, the fixed measure has a tip reference surface and an inner reference surface formed at the tip thereof, which are parallel to the bottom surface of the main plate, the fixed measure and the moving measure have a scale for indicating a distance between the bottom surface of the main plate and a tip reference surface, and a scale indicating a distance between the bottom surface of the main plate and an inner reference surface.

### BACKGROUND OF THE INVENTION

1. Field of the Invention

The present invention relates to an apparatus for measuring the height of mounting positions of a cutting knife and a pressure bar in a veneer lathe. The apparatus is used for checking the dislocation amount of the mounting positions of the cutting knife and the pressure bar mounted on the veneer lathe. The veneer lathe rotates a log while retaining both end surfaces thereof and pressed to the entire length of the rotating log by a tip of the pressure bar. Then a cutting edge of the cutting knife mounted the veneer lathe bites into the adjacent area of the pressing position at each specified amount so as to continuously peel the log, and thereby obtaining veneers as a material for plywood.

2. Description of the Related Art

When the veneer is continuously peeled from the log with the veneer lathe, both the end surfaces of the log are sandwiched by spindles provided on the right and left sides thereof. The log so sandwiched is rotated by the rotation of the spindle, or by the torque applied from the outer periphery the log with the rotation drive unit. The veneer lathe includes the cutting knife and the pressure bar. The cutting knife peels the outer periphery surface of the entire length of the rotating log by a specified amount so as to peel the log. The pressure bar provided in parallel to the cutting knife in the adjacent area of the upstream of the rotating direction of the log, which moves together with the cutting knife while pressing the outer periphery surface of the log thereto at a specified pressure.

When peeling the log with the cutting knife while rotating the log in the veneer lathe, the positional relation among the height of the rotating shaft axis of the log, i.e. the height of the shaft axes of the right and left spindles, the height of the cutting edge line of the cutting knife, and the height of the pressure contact line of the pressure bar against the log, i.e. the edge line of the pressure bar, and the parallel states thereof are important elements of the cutting conditions for determining the quality of the veneers to be peeled. Therefore, before starting to peel the log, it is important to place the cutting edge line of the cutting knife and the edge line of the pressure bar at accurate height relative to the height of the shaft axes of both the right and left spindles.

The cutting knife 54 in the veneer lathe is, as shown in FIG. 9, assembled with a knife holder 53 with a fastener such as a bolt, and which can be mounted on a knife carriage 52 of the veneer lathe together with the knife holder 53. The knife carriage 52 is provided a drive unit for moving in the horizontal direction, because it needs to repeatedly move forwardly and backwardly relative to the log 50. However, there is not actually provided with a drive unit for movement in the vertical direction, which is required to adjust a height K of the cutting edge line of the cutting knife 54.

Accordingly, the height K of the cutting edge line when the cutting knife 54 is mounted on the veneer lathe depends on a mounting dimension L from the bottom of the knife holder 53 to the cutting edge line of the cutting knife 54 as shown in FIG. 9. A reference value A of the mounting dimension L is specified for each veneer lathe. And generally, if the reference value A of the mounting dimension L is kept, the height of the shaft axis of the spindle 51 matches with the height of the cutting edge line of the cutting knife 54. In addition, the reference value A of the mounting dimension L from the bottom of the knife holder 53 to the cutting edge line of the cutting knife 54 is an important dimension that must be strictly managed until the veneer lathe is discarded. In order to obtain the specified height K of the cutting edge line using the reference value A of the mounting dimension L as the reference, as shown in FIG. 10, a jig 61 and a reference block 62 are used. The jig 61 determines the height L from the bottom of the knife holder 53 as the reference to the cutting edge line of the cutting knife 54. The reference block 62 is formed to have the same length as the reference value A of the mounting dimension L.

There is a veneer lathe in which the knife holder 53 is not provided and the cutting knife 54 is directly mounted on the knife carriage 52. In this case, a method for adjusting the height of the cutting edge line using a jig disclosed in FIGS. 1 and 2 in Japanese Unexamined Patent Application Publication No. 8-197501 is applied.

The veneer lathe is generally constructed in a manner such that the pressure bar 56 moves forwardly or backwardly toward the center of the log 50 on a line crossing the horizontal line so as to open by approximately 12 degrees upward on the backward side for adjusting the positional relation relative to the cutting edge line of the cutting knife 54. Therefore, a height P of the edge line of the pressure bar 56 is determined as a vertical directional component of the angle (approximately 12 degrees) due to the forward and backward movement of the pressure bar 56. In addition, the height of the pressure bar 56 can be adjusted on the right and left sides by vertical adjusting means provided for a pressure-bar supporting frame 55.

If the veneer lathe is new and assembled with parts manufactured with a high accuracy in dimension according to the design, the height K of the cutting edge line of the cutting knife 54 as well as the height P of the edge line of the pressure bar 56 may be normal when manufactured according to the specified dimensions and mounted on the veneer lathe according to the standard. However, such conditions are never satisfied because dislocations in dimension occur when manufacturing and assembling the parts of the veneer lathe. Therefore, after completion of assembling the apparatus, it is always required to know the accurate positional relation in dimension, between the height K of the cutting edge line of the cutting knife 54 and the height P of the edge line of the pressure bar 56, relative to the height of the shaft axis of the spindle 51. Only by measuring such dimensions, the reference value A of the mounting dimension L from the bottom of the knife holder 53 to the cutting edge line of the cutting knife 54 can be determined.

In addition, since the veneer lathe is hard used for a long period, a dislocation may inevitably occurs in the parts of the apparatus due to wear or the like. And, as a result, even if the cutting knife 54 is assembled with the knife holder 53 while strictly keeping the reference value A of the mounting dimension L from the bottom of the knife holder 53 to the cutting edge line of the cutting knife 54, an dislocation in dimension corresponding the play may occur due to wear or the like of the parts of the apparatus. Also, the dislocation in dimension may similarly occur in the case of the pressure bar 56. Such dislocations in dimension may affect the positional relation between the height of the rotating shaft axis of the log 50 and the height of the cutting edge line of the cutting knife 54, the positional relation between the height of the rotating shaft axis of the log 50 and the height of the edge line of the pressure bar 56, and the parallel states thereof. Consequently, the quality of the veneers peeled by the veneer lathe in such a state is poor.

In order to prevent such a state, it is required to know the dislocation amount of the height of the cutting edge line of the cutting knife 54 relative to the height of the shaft axis of the spindle 51, and the dislocation amount of the height of the edge line of the pressure bar 56 relative to the height of the shaft axis of the spindle 51. And, by these dislocation amount, it is required to compensate the reference value A of the mounting dimension L from the bottom of the knife holder 53 to the cutting edge line of the cutting knife 54, to compensate a scale for feeding the pressure bar 56, or to vertically adjust the pressure bar 56 with the vertical adjusting means provided for the pressure-bar supporting frame 55 on the right and left sides.

Conventionally, the dislocation amount in dimension has been measured using a plurality of jigs and measuring apparatus such as an L-shaped or Z-shaped plate, a level, and slide calipers. Therefore the jigs and measuring apparatus and the measuring method are varied depending on the person who measured at the assembling site of the apparatus and at the cutting site of the log. As a result, the measurement result is varied depending on the person who measured. Also, at the cutting site of the log, there are many cases in which the logs are continuously peeled without checking the dislocation amounts for a long period because of the troublesome, causing a serious problem later.

### SUMMARY OF THE INVENTION

The present invention is made in consideration of the drawback of the above-described conventional measuring method. It is an object of the present invention to provide an apparatus for measuring the height of mounting positions of a cutting knife and a pressure bar in a veneer lathe, in which an dislocation amount of the positional relation between the height of shaft axes of right and left spindles for rotating a log and the height of a cutting edge line of the cutting knife, and between the height of the shaft axes of the right and left spindles and the height of a edge line of the pressure bar in the veneer lathe can be checked only by providing one apparatus.

In order to achieve the above object, according to a first aspect of the present invention, there is provided an apparatus for measuring the height of mounting positions of a cutting knife and a pressure bar in a veneer lathe, comprising: a generally rod-shaped main plate having an upper surface and a lower surface, in which at least the bottom surface is planer; a level for measuring the level state of the bottom surface of the main plate in a longitudinal direction thereof; a fixed measure provided for the main plate on one end side in the longitudinal direction thereof, in which a feed section perpendicular to the bottom surface of the main plate is provided; and a moving measure held in the feed section of the fixed measure, which can be moved in a direction perpendicular to the bottom surface of the main plate, wherein the moving measure includes: a tip reference surface formed at an end of the main plate on the bottom surface side, which is perpendicular to the moving direction of the moving measure; and an inner reference surface formed in the adjacent area of the end of the main plate on the bottom surface side, which is parallel to the tip reference surface, and wherein the fixed measure and the moving measure include: a scale for indicating a distance between the tip reference surface and the bottom surface of the main plate; and a scale for indicating a distance between the inner reference surface and the bottom surface of the main plate.

With such a structure, the position of the moving measure is set with the scales provided for the fixed measure and the moving measure so that the distance between the tip reference surface of the moving measure and the bottom surface of the main plate is as long as the radius of the outer periphery of the spindle for rotating the log in the veneer lathe. Then, if the bottom surface of the main plate is placed on the outer periphery surface of the spindle, and the bottom surface of the main plate is horizontally held in the longitudinal direction with the level, the tip reference surface of the moving measure is as high as the shaft axis of the spindle. In addition, the position of the moving measure is set with the scales provided for the fixed measure and the moving measure so that the distance between the inner reference surface of the moving measure and the bottom surface of the main plate is as long as the radius of the outer periphery of the spindle of the veneer lathe. Then, if the bottom surface of the main plate is placed on the outer periphery surface of the spindle, and the bottom surface of the main plate is horizontally held in the longitudinal direction with the level, the inner reference surface of the moving measure is as high as the shaft axis of the spindle.

Accordingly, the distance between the tip reference surface of the moving measure and the bottom surface of the main plate is matched with the height of the normal cutting edge line of the cutting knife with the scale by including the difference between the height of the shaft axis of the spindle and the height of the cutting edge line of the cutting knife, which are obtained when actually peeling the log. And the bottom surface of the main plate is placed on the outer periphery surface of the spindle, and the bottom of the main plate is kept horizontally in the longitudinal direction. Then, the tip reference surface of the moving measure indicates a normal height of the cutting edge line of the cutting knife. Accordingly, if the main plate is moved in a manner such that the tip of the moving measure comes onto the cutting edge of the cutting knife or in the adjacent area thereof in a state in which the bottom surface of the main plate is maintained horizontally, the dislocation amount of the height of the cutting edge line of the cutting knife is shown as a gap between the tip reference surface of the moving measure and the cutting edge of the cutting knife, or an overlapping amount. Similarly, the distance between the inner reference surface of the moving measure and the bottom surface of the main plate is matched with the height of the normal edge line of the pressure bar with the scale by including the difference between the height of the shaft axis of the spindle and the height of the edge line of the pressure bar, which are obtained when actually peeling the log. And the bottom surface of the main plate is placed on the outer periphery surface of the spindle, and the bottom of the main plate is kept horizontally in the longitudinal direction. Then, the inner reference surface of the moving measure indicates a normal height of the edge line of the pressure bar. Accordingly, if the main plate is moved in a manner such that the inner reference surface of the moving measure comes under the tip of the pressure bar in a state in which the bottom surface of the main plate is maintained horizontally, the dislocation amount of the height of the edge line of the pressure bar is shown as a gap between the inner reference surface of the moving measure and the bottom surface of the tip of the pressure bar, or an overlapping amount.

In the apparatus for measuring the height of mounting positions of a cutting knife and a pressure bar in a veneer lathe, preferably, the main plate includes a level-adjusting and -keeping rod at an end in the longitudinal direction, at which the fixed measure is provided, the level-adjusting and -keeping rod capable of being moved forwardly and backwardly along a straight line crossing the bottom surface of the main plate at a specified angle within a plane perpendicularly crossing the bottom surface of the main plate in the longitudinal direction of the main plate, and which can be fixed at a predetermined projecting position.

With such a structure, the bottom surface of the main plate is placed on the outer periphery surface of the spindle while a tip of the level-adjusting and -keeping rod is placed on a stable part such as a supporting frame of the pressure bar. The level-adjusting and -keeping rod is moved so that the bottom surface of the main plate is level with the level. The movement of the level-adjusting and -keeping rod is restricted at a position where the bottom surface of the main plate becomes level. And the tip reference surface of the moving measure is brought into contact with the cutting edge of the cutting knife. As a result, the height of the cutting edge line of the cutting knife at that time is shown by the scale indicating the distance between the tip reference surface of the moving measure and the bottom surface of the main plate as compared with the radius of the outer periphery of the spindle. Accordingly, an actual dislocation amount of the cutting edge line of the cutting knife relative to the normal height of mounting can be known.

Also, by bringing the inner reference surface of the moving measure into contact with the bottom surface of the tip of the pressure bar in a manner so as to hang thereunder, the actual dislocation amount of the tip of the pressure bar at that time relative to the normal height of mounting can be known by the scale indicating the distance between the inner reference surface of the moving measure and the bottom surface of the main plate.

Also, if dislocation amounts of the cutting knife and the pressure bar relative to the normal heights of the right and left spindles are known using the right and left spindles, dislocation amounts of the parallel state of the cutting knife and the pressure bar relative to the shaft axis of the spindle can be also known.

In the apparatus for measuring the height of mounting positions of a cutting knife and a pressure bar in a veneer lathe, preferably, the fixed measure provided for the main plate on an end side in the longitudinal direction can be moved in parallel to the bottom surface of the main plate in the longitudinal direction of the main plate.

With such a structure, the tip reference surface of the moving measure can be easily moved to the upper part of the cutting edge line of the cutting knife, and the inner reference surface of the moving measure can be easily moved to the bottom surface of the tip of the pressure bar. Then, the main plate being placed on the outer periphery of the spindle and held in a level state is not moved on the outer periphery surface of the spindle. Consequently, the dislocation amounts relative to the normal heights can be checked more quickly.

In the apparatus for measuring the height of the mounting positions of the cutting knife and the pressure bar in the veneer lathe, preferably, an apparatus for engaging a feed section of the fixed measure and the moving measure held in the feed section of the fixed measure is specified. Moreover, the feed section provided for the fixed measure may be a slide groove, and the part of the moving measure, which is held in the feed section of the fixed measure, may have a shape slidably engaging with the slide groove of the fixed measure.

According to the first aspect of the present invention, there is also provided an apparatus for measuring the height of the mounting positions of the cutting knife and the pressure bar in the veneer lathe, in which the feed section provided for the fixed measure is a female screw, and the part of the moving measure, which is held in the feed section of the fixed measure is a male screw engaging with the female screw of the fixed measure.

With such a structure, the moving measure can be surely fed relative to the fixed measure, and the distance between the bottom surface of the main plate and the tip reference surface of the moving measure and the distance between the bottom surface of the main plate and the inner reference surface of the moving measure can be accurately known.

Next, according to the present invention, there is also provided a veneer lathe having an apparatus for measuring the height of mounting positions of a cutting knife and a pressure bar in a veneer lathe. With such a structure, the relation between the height of the rotating shaft axis of the log and the height of the cutting edge line of the cutting knife can be known. Also the relation between the height of the rotating shaft axis of the log and the height of the edge line of the pressure bar can be known. As a result, the positional relation in the vertical direction, which is most appropriate for the peeling condition determined depending on the kind of the log and the thickness of the veneer, can be kept in a normal state. Therefore, the quality of the peeled veneers can be maintained in the best state.

### BRIEF DESCRIPTION OF THE DRAWINGS

FIG. 1 is a front view showing an embodiment of an apparatus for measuring the height of mounting positions of a cutting knife and a pressure bar in a veneer lathe according to the present invention;

FIG. 2 is a plan view of the apparatus in FIG. 1;

FIG. 3 illustrates the procedure for checking an dislocation amount of the height of the cutting knife on the side of a cutting edge with the apparatus for measuring the height of the mounting positions of the cutting knife and the pressure bar in the veneer lathe according to the present invention;

FIG. 4 illustrates the procedure for checking an dislocation amount of a edge line of the pressure bar with the apparatus for measuring the height of the mounting positions of the cutting knife and the pressure bar in the veneer lathe according to the present invention;

FIG. 5 is a front view showing another embodiment of the apparatus for measuring the height of the mounting positions of the cutting knife and the pressure bar in the veneer lathe according to the present invention;

FIG. 6 is a plan view of the apparatus in FIG. 5;

FIG. 7 is a front view of still another embodiment of the apparatus for measuring the height of the mounting positions of the cutting knife and the pressure bar in the veneer lathe according to the present invention;

FIG. 8 is a side elevational view of the apparatus in FIG. 8;

FIG. 9 is a schematic view showing a positional relation among a spindle, the cutting knife, and the pressure bar in the veneer lathe; and

FIG. 10 illustrates a jig and a reference block used for assembling the cutting knife with a knife holder.

### DESCRIPTION OF THE PREFERRED EMBODIMENTS

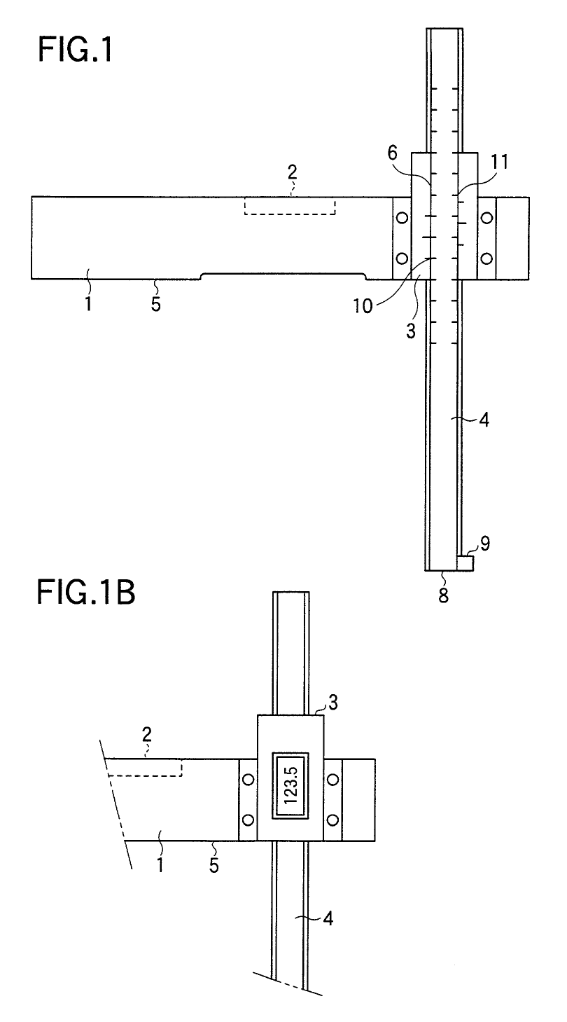

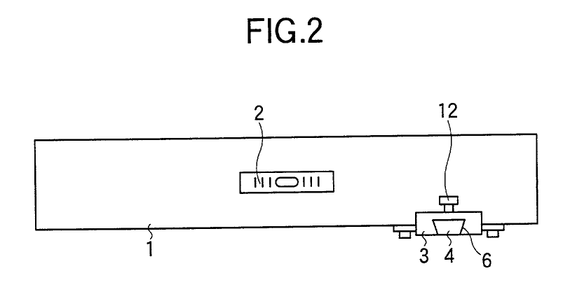

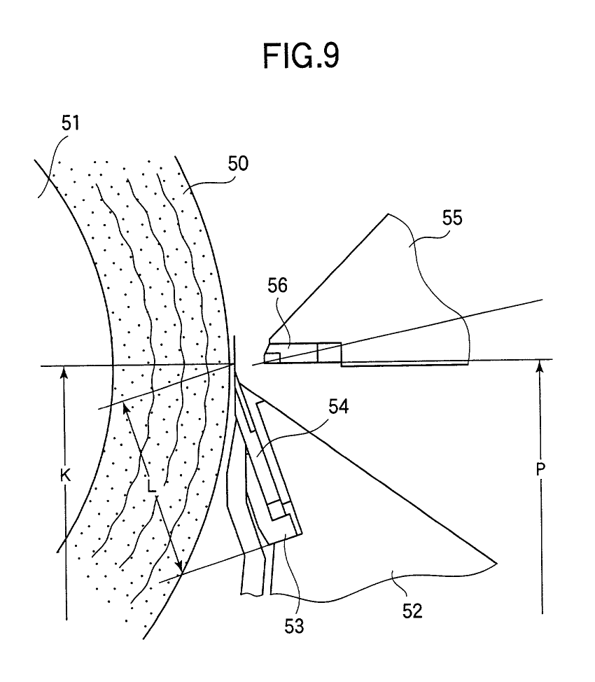

Embodiments of the present invention will be described hereinbelow with reference to FIGS. 1 to 8. FIGS. 1 to 2 show an embodiment of the present invention. FIG. 1 is a front view thereof and FIG. 2 is a plan view of the apparatus in FIG. 1. The apparatus for measuring the height of the mounting positions of the cutting knife and the pressure bar in the veneer lathe according to the present invention, comprises, for example as shown in the drawings, a generally-rectangular-rod-like main plate 1, a level 2 provided for the main plate 1, a fixed measure 3 fixed to the main plate on one end side thereof, and a moving measure 4 held in the fixed measure 3. The main plate 1 is formed longer than a distance between a vertical plane at the shaft axis of a spindle 51 for rotating a log 50 and a vertical plane at the edge line of a pressure bar 56 in the veneer lathe, the scheme of which is shown in FIG. 9. A bottom surface 5 of the main plate 1 is formed to a plane surface. The main plate 1 has the level 2 for checking the level state of the bottom surface 5 of the main plate in a longitudinal direction.

The fixed measure 3 provided for the main plate 1 on an end side thereof has a feed section 6 that is perpendicular to the bottom surface 5 of the main plate or the extended surface thereof. The feed section 6 of the fixed measure 3 slidably holds the moving measure 4. Therefore, the moving measure 4 held in the feed section 6 of the fixed measure 3 can be moved in a direction perpendicular to the bottom surface 5 of the main plate or the extended surface thereof. In addition, an end of the moving measure 4, which is on the bottom surface 5 side of the main plate, is formed to a hook shape. The end of the moving measure 4 has a tip reference surface 8 and an inner reference surface 9. The tip reference surface 8 and the inner reference surface 9 are perpendicular to the moving direction of the moving measure 4, and the inner reference surface 9 are parallel to the bottom surface 5 of the main plate.

On the other hand, there are provided a scale 10 and a scale 11 in front of the fixed measure 3 and the moving measure 4. The scale 10 indicates a distance from the bottom surface 5 of the main plate to the tip reference surface 8 of the moving measure 4. The scale 11 indicates a distance from the bottom surface 5 of the main plate to the inner reference surface 9 of the moving measure 4. The moving measure 4 is long enough to indicate a distance longer than a radius of an outer periphery of the spindle 51 for rotating the log 50 of the veneer lathe with the scales 10 and 11. In addition, a setscrew 12 provided at the upper back surface of the fixed measure 3 is for restricting the movement of the moving measure 4. The setscrew 12 can lock the moving measure 4 in the fixed measure 3 at an arbitrary position.

FIG. 1B shows a state in which a scale for indicating the distance between the tip reference surface 8 of the moving measure 4 and the bottom surface 5 of the main plate, and the distance between the inner reference surface 9 and the bottom surface 5 of the main plate is digitally displayed. On the other hand, a scale for indicating the distance between the tip reference surface 8 of the moving measure 4 and the bottom surface 5 of the main plate, and the distance between the inner reference surface 9 and the bottom surface 5 of the main plate can be made a combination of a scale provided in front of the moving measure 4 and a scale of a dial gauze provided on the fixed measure 3 side.

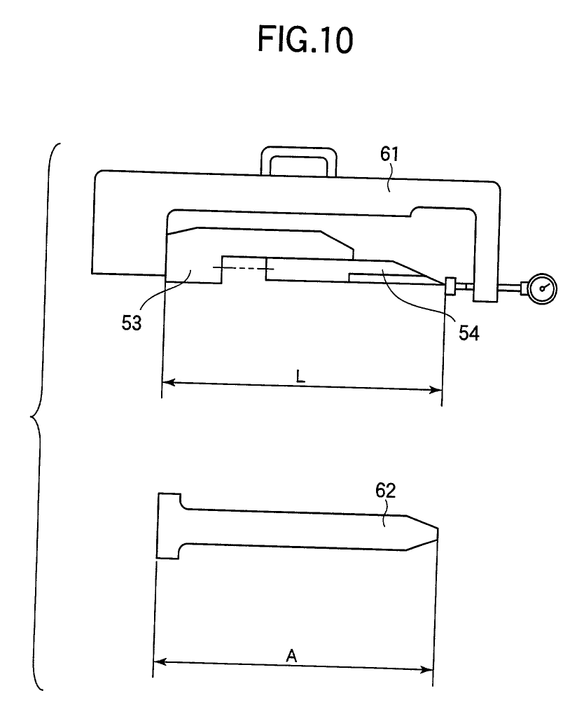

A procedure for checking an dislocation amount of the height of a cutting edge line of a cutting knife 54 with the apparatus for measuring the height of the mounting positions of the cutting knife and the pressure bar in the veneer lathe according to the present invention will be described hereinbelow. This procedure will be described using a veneer lathe as an example, in which when the cutting knife 54 is mounted on a knife holder 53 using a jig 61 as shown in FIG. 10, while matching a mounting length L from the base of the knife holder 53 to the cutting edge line of the cutting knife 54 with a length A of a reference block 62, and then which is assembled with a knife carriage 52 of the veneer lathe, a height K of the cutting edge line of the cutting knife 54 and the height of a shaft axis of the spindle 51 are the same.

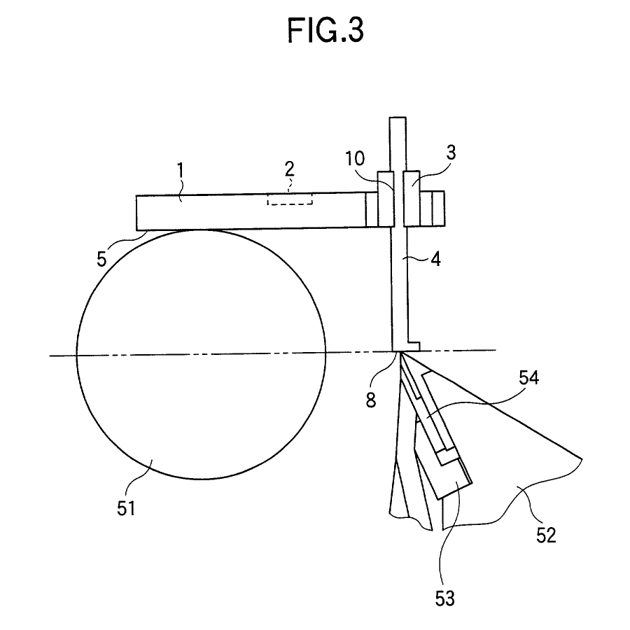

The moving measure 4 slidably held in the fixed measure 3 is moved along the feed section 6 of the fixed measure 3 so as to adjust with the scale 10 so that the distance between the tip reference surface 8 of the moving measure 4 and the bottom surface 5 of the main plate is as long as the radius of the outer periphery of the spindle 51 for rotating the log in the veneer lathe. Then the moving measure 4 is fixed to the fixed measure 3 with the setscrew 12 in such a state. Subsequently, the bottom surface 5 of the main plate is placed on the outer periphery surface of the spindle 51 of the veneer lathe as shown in FIG. 3. Then, the main plate 1 is put on the spindle 51 so that the tip reference surface 8 provided at the tip of the moving measure 4 comes onto the cutting edge line of the cutting knife 54 or in the adjacent area thereof. And the bottom surface 5 of the main plate is held in a level state in a longitudinal direction with the level 2 provided for the main plate 1, while being placed on the spindle 51. A deviation amount between the cutting edge line of the cutting knife 54 and the tip reference surface 8 is the dislocation amount of the height of the cutting edge line of the cutting knife 54 relative to the normal height thereof.

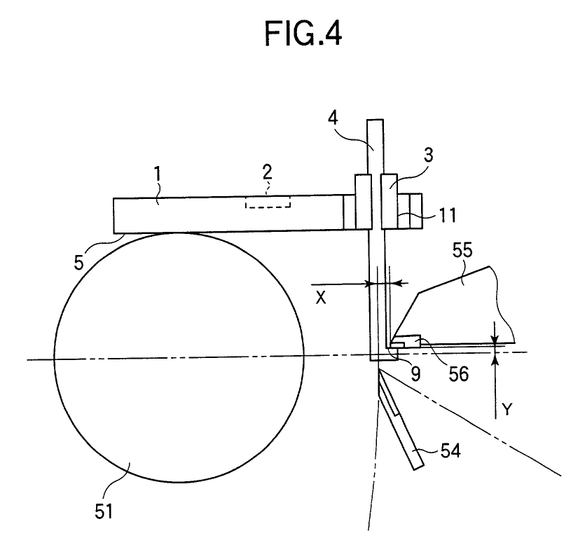

A procedure for checking the dislocation amount of the height of the edge line of the pressure bar 56 with the apparatus for measuring the height of the mounting positions of the cutting knife and the pressure bar in the veneer lathe according to the present invention will be described hereinbelow. This procedure will be described using a veneer lathe as an example, in which, as shown in FIG. 4, a state in which when the edge line of the pressure bar 56 of the veneer lathe is horizontally separated from the cutting edge line of the cutting knife 54 by X mm, a height P of the edge line of the pressure bar 56 is higher than the height of the shaft axis of the spindle 51 by Y mm is normal mounting of the pressure bar 56.

In a manner similar to the case of the cutting edge line of the cutting knife 54, the moving measure 4 slidably held in the fixed measure 3 is moved along the feed section 6 of the fixed measure 3. Then the moving measure 4 is moved to adjust with the scale 11 so that the distance between the inner reference surface 9 provided for the moving measure 4 on the tip side and the bottom surface 5 of the main plate is shorter than the radius of the outer periphery of the spindle 51 for rotating the log of the veneer lathe by Y mm. The moving measure 4 is fixed to the fixed measure 3 with the setscrew 12 in such a state. Subsequently, as shown in FIG. 4, the bottom surface 5 of the main plate is placed on the outer periphery surface of the spindle 51 of the veneer lathe. In this instance, the main plate 1 is placed on the spindle 51 so that the inner reference surface 9 provided at the tip of the moving measure 4 comes in the adjacent area of the edge line of the pressure bar 56. Then, the bottom surface 5 of the main plate is held in a level state in a longitudinal direction with the level 2 provided for the main plate 1, while being placed on the spindle 51. A deviation amount between the edge line of the pressure bar 56 and the inner reference surface 9 in such a state is the dislocation amount of the height of the edge line of the pressure bar 56 relative to a normal height thereof.

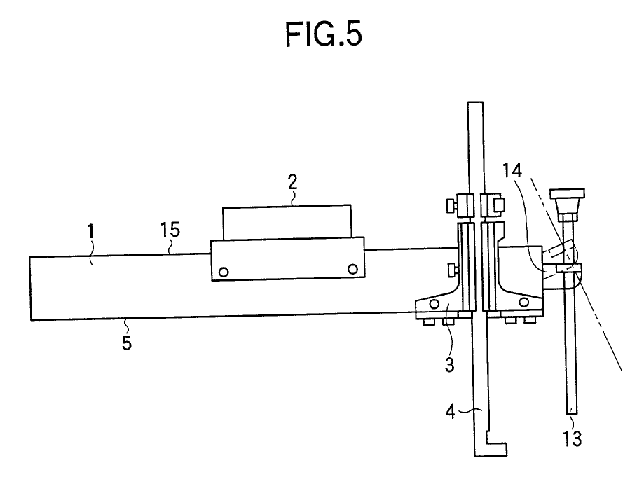

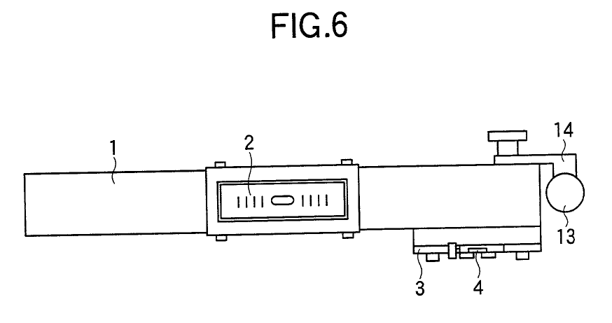

FIGS. 5 and 6 show another embodiment of the present invention. FIG. 5 is a front view thereof and FIG. 6 is a plan view of the apparatus in FIG. 5. An apparatus for measuring the height of the mounting positions of the cutting knife and the pressure bar in the veneer lathe according to this embodiment has the main plate 1, the level 2, the fixed measure 3, the moving measure 4 held in the fixed measure 3, and a level-adjusting and -keeping rod 13 provide on an end of the main plate 1. The end of the main plate 1 is an end of the side provided fixed measure 3 in the main plate 1.

The level-adjusting and -keeping rod 13 is retained in a keeping-rod retainer 14 in a manner so as to be moved forwardly and backwardly. The keeping-rod retainer 14 is provided for the main plate 1 in a manner so as to be rotated and retained at an arbitrary position. The level-adjusting and -keeping rod 13 can be tilted at an arbitrary angle within a plane perpendicularly crossing the bottom surface 5 of the main plate in a longitudinal direction of the main plate 1. The level-adjusting and -keeping rod 13 is movably retained in the keeping-rod retainer 14 with an engaging apparatus such as a screw or a combination of a rack and a pinion. Because the forward and backward movement of the level-adjusting and -keeping rod 13 relative to the keeping-rod retainer 14 is required to be finely adjusted. In addition, the level-adjusting and -keeping rod 13 is longer than the length where the tip of the level-adjusting and -keeping rod 13 comes into contact with, for example, a predetermined position above a pressure-bar supporting frame 55 of the veneer lathe when the main plate 1 is placed on the upper surface of the spindle 51 of the veneer lathe and the bottom surface 5 of the main plate is held in the level state in the longitudinal direction thereof.

In the apparatus for measuring the height of the mounting positions of the cutting knife and the pressure bar in the veneer lathe according to this embodiment, the level 2 is fixed to an upper surface 15 of the main plate in a state in which the level state of the bottom surface 5 of the main plate in the longitudinal direction can be checked. Also, in this embodiment, the fixed measure 3 has the similar shape to that of a base of a commercially available depth gauge, and the moving measure 4 has the similar shape to that of a main measure of the commercially available depth gauge with a hook.

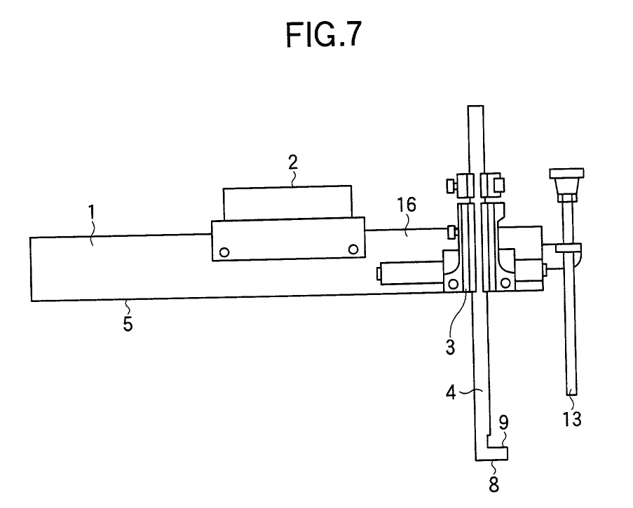

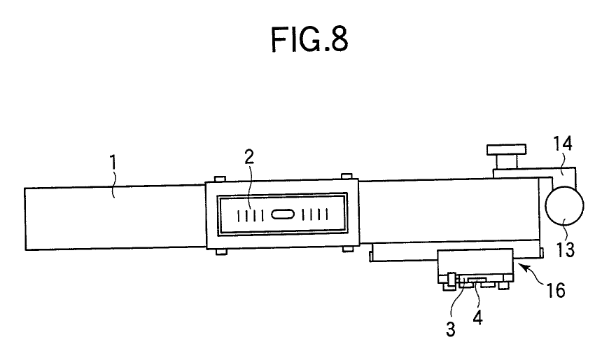

FIGS. 7 and 8 shows still another embodiment of the present invention. FIG. 7 is a front view thereof, and FIG. 8 is a side-elevational view of the apparatus in FIG. 7. In an apparatus for measuring the height of the mounting positions of the cutting knife and the pressure bar in the veneer lathe according to this embodiment, the fixed measure 3 can be moved in parallel to the bottom surface 5 of the main plate and in the longitudinal direction of the main plate 1 by a longitudinal motion mechanism 16. Since the fixed measure 3 can be moved in parallel to the bottom surface 5 of the main plate, a deviation does not occur in the relation between the scales 10 and 11, which are respectively provided at the fixed measure 3 and the moving measure 4, relative to the tip reference surface 8 and the inner reference surface 9 of the moving measure 4.

Therefore, in the apparatus for measuring the height of the mounting positions of the cutting knife and the pressure bar in the veneer lathe according to this embodiment, the bottom surface 5 of the main plate 1 has been made level by the level-adjusting and -keeping rod 13, and the tip reference surface 8 or the inner reference surface 9 of the moving measure 4 can be easily respectively moved onto the cutting edge line of the cutting knife 54 or in the adjacent area of the pressure bar 51 without moving the main plate 1.

In this embodiment, a mechanism in which the fixed measure 3 can be moved in the longitudinal direction of the main plate 1 using the longitudinal motion mechanism is shown. But it is not limited to the above mechanism. A structure in which the fixed measure 3 can be moved in parallel to the bottom surface 5 of the main plate is possible, for example, a structure in which the fixed measure 3 is moved by sliding using a combination of a dovetail and a dovetail groove is possible.

In addition, in the case of a structure in which the female screw and the male screw are used as the engaging means of the feed section 6 of the fixed measure 3 with the moving measure 4, it is possible to use a commercially available rod-type depth micrometer or the like. In this case, the tip of the moving measure 4 may have a hook-shape or a disc-like flange shape. In addition, the engaging means in which the feed section 6 of the fixed measure 3 is engaged with the moving measure 4 so as to be fitted by sliding can assemble the rack and the pinion as a feeding means.

In the description of the embodiments of the present invention, the main plate 1 has a rectangular-rod shape. However, the shape of the main plate 1 is not limited to the rectangular-rod shape. The main plate 1 may have a semi-cylindrical shape, or may be a member having a gourd shape or a long hole shape in horizontal cross section. Also, in the description of the embodiments of the present invention, the main plate 1 in which the entire bottom surface 5 thereof is planer has been described. However, only a portion of the bottom surface 5 of the main plate 1 to be placed on the outer periphery of the spindle 51 of the veneer lathe may be planer. The bottom surface 5 of the main plate 1 may have an escape portion. In this case, of course, the planer bottom surface is a reference surface relative to the scales 10 and 11, and the level state of the planer bottom surface can be checked with the level 2.

According to the present invention, the dislocation amounts in the positional relation between the height of the shaft axis of the spindle for rotating the log and the height of cutting edge line of the cutting knife, and between the height of the shaft axis of the spindle and the height of the edge line of the pressure bar, and the parallel states thereof in the veneer lathe can be easily checked with one apparatus. Consequently, even if the veneer lathe is so old that there is dislocation in size of the parts due to the wear, the relation among the height of the shaft axes of the spindles, the height of the cutting edge line of the cutting knife, and the height of the edge line of the pressure bar can be securely maintained at the normal relational positions. Accordingly,-the best positional relation in the vertical direction for the most appropriate peeling condition that is determined depending on the kind of the log, the thickness of the veneer to be peeled, and the like can be obtained. As a result, the quality of the veneer so peeled is constantly the best.

What is claimed is:

1. An apparatus for measuring the height of mounting positions of a cutting knife and a pressure bar in a veneer lathe, comprising:
a generally rod-shaped main plate-having an upper surface and a lower surface, in which at least said bottom surface is planer;
a level for measuring a level state of the bottom surface of the main plate in a longitudinal direction;
a fixed measure provided for said main plate on one end side thereof in the longitudinal direction, and having a feed section perpendicular to the bottom surface of said main plate; and
a moving measure held in the feed section of said fixed measure, which can be moved in a direction perpendicular to the bottom surface of said main plate, said moving measure includes:
a tip reference surface formed at an end of said main plate on the bottom surface side, which is perpendicular to the moving direction of said moving measure; and
an inner reference surface formed in the adjacent area of the end of said main plate on the bottom surface side, which is parallel to said tip reference surface, and
said fixed measure and said moving measure include:
a scale for indicating a distance between said tip reference surface and the bottom surface of said main plate; and
a scale for indicating a distance between said inner reference surface and the bottom surface of said main plate.

2. An apparatus for measuring the height of mounting positions of a cutting knife and a pressure bar in a veneer lathe according to claim 1, wherein said main plate includes a level-adjusting and -keeping rod at an end in the longitudinal direction, at which said fixed measure is provided, the level-adjusting and -keeping rod capable of being moved forwardly and backwardly along a straight line crossing the bottom surface of said main plate at a specified angle within a plane perpendicularly crossing the bottom surface of said main plate in the longitudinal direction of said main plate, and which can be fixed at a predetermined projecting position.

3. An apparatus for measuring the height of mounting positions of a cutting knife and a pressure bar in a veneer lathe according to claim 1, wherein said fixed measure provided for said main plate on an end side in the longitudinal direction can be moved in parallel to the bottom surface of said main plate in the longitudinal direction of said main plate.

4. An apparatus for measuring the height of mounting positions of a cutting knife and a pressure bar in a veneer lathe according to claims 1, wherein said feed section provided for said fixed measure is a slide groove, and a part of said moving measure, which is held in the feed section of said fixed measure, has a shape slidably engaging with said slide groove of said fixed measure.

5. An apparatus for measuring the height of mounting positions of a cutting knife and a pressure bar in a veneer lathe according to claims 1, wherein said feed section provided for said fixed measure is a female screw, and a part of said moving measure, which is held in the feed section of said fixed measure is a male screw engaging said female screw of said fixed measure.

6. A veneer lathe having an apparatus for measuring the height of mounting positions of a cutting knife and a pressure bar in a veneer lathe according to claims 1.
